(19) United States
(12) Patent Application Publication
(10) Pub. No.: US 2016/0286308 A1
(43) Pub. Date: Sep. 29, 2016

(54) SEPARABLE FLOATING WATER SHOW SPEAKER

(71) Applicant: Tsan-Yao CHEN, Taipei (TW)

(72) Inventor: Tsan-Yao CHEN, Taipei (TW)

(21) Appl. No.: 14/669,684

(22) Filed: Mar. 26, 2015

(51) Int. Cl. H04R 1/44; H04R 1/02

(52) U.S. Cl. CPC H04R 1/44; H04R 1/02

(57) ABSTRACT

A separable floating water show speaker is revealed. The water show speaker includes a first control unit used in water, a second control unit used on a flat surface and an audio unit. The separable audio unit can be connected either to the first control unit for being used in the water or to the second control unit for being used on the flat surface. When music is displayed, the first control unit of the speaker is also activated to show a plurality of dynamic effects including rotation, dancing water show, audio visual effect, etc.

### BACKGROUND OF THE INVENTION

1. Fields of the invention

The present invention relates to a speaker, especially to a separable floating water show speaker.

2. Descriptions of Related Art

Besides playing sounds, speakers are used for entertainment or as ornaments. The structure of the speaker is improved constantly for convenience in use. For example, the speaker includes a light module that emits light along with different sounds played under control of a control circuit. Thus the speaker provides various visual and audio effects and looks like a merry-go-around.

However, conventional speakers don't have the design of separable speakers.

### SUMMARY OF THE INVENTION

Therefore it is a primary object of the present invention to provide a separable floating water show speaker that features on a separable audio unit.

It is another object of the present invention to provide a separable floating water show speaker that features on durability and portability.

In order to achieve the above objects, a separable floating water show speaker of the present invention includes a first control unit, a second control unit and an audio unit. The first control unit composed of a housing, a pump and a first control circuit is suitable to be used in water. The housing consists of an upper hosing and a lower housing with a hollow air chamber therebetween so that the housing can float in the water. A bottom surface of the lower housing is arranged with a water inlet while a plurality of first spray holes is mounted on and penetrating a top surface of the upper housing. At least one channel for communicating the first spray holes with the water inlet is also arranged at the housing. The top surface of the upper housing is set with a first connection part and the first connection part includes at least three first magnets. The pump is mounted in the housing and an input end of the pump is communicated with the outside through the water inlet of the housing. The first control circuit is disposed in the housing and is electrically connected to the pump for control of the pump. After being turned on, the pump draws the water through the water inlet of the housing and forces the water through the channel and the first spray holes to be jetted in the form of a column. The second control unit is used on a flat surface. The second control unit consists of a base, a second control circuit mounted in the base, and a second connection part disposed on one side of the base. The second connection part includes at least three second magnets. The audio unit is composed of a speaker enclosure with at least one speaker driver. The speaker driver is for receiving an audio signal from the first control unit or the second control unit and sending the audio signal to the speaker driver to be played. A third connection part is set on one side of the speaker enclosure. The third connection part includes at least three third magnets. The third magnets and the first magnets attract each other correspondingly and so are the third magnets and the second magnet. Thereby the third connection part on the speaker enclosure is connected to the first connection part of the first control unit/or the second connection part of the second control unit by means of the magnetic force.

The first control unit sends an audio signal to the speaker driver when the three third magnets and the three first magnets are attracted and electrically connected.

The second control unit sends an audio signal to the speaker driver when the three third magnets and the three second magnets are attracted and electrically connected.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment according to the present invention;

FIG. 2 is perspective view of a first control unit and an audio unit separated from each other of an embodiment according to the present invention;

FIG. 3 is an explosive view of a first control unit and an audio unit separated from each other of an embodiment according to the present invention;

FIG. 4 is another explosive view of a first control unit and an audio unit separated from each other of an embodiment according to the present invention;

FIG. 5 is a side view of the embodiment in FIG. 1;

FIG. 6 is a bottom view of the embodiment in FIG. 1;

FIG. 7 is a vertical sectional view of the first control unit and the audio unit of the embodiment in FIG. 1;

FIG. 8 is perspective view of a second control unit and an audio unit separated from each other of an embodiment according to the present invention;

FIG. 9 is an explosive view of a second control unit and an audio unit separated from each other of an embodiment according to the present invention.

### DETAILED DESCRIPTION OF THE PREFFERED EMBODIMENT

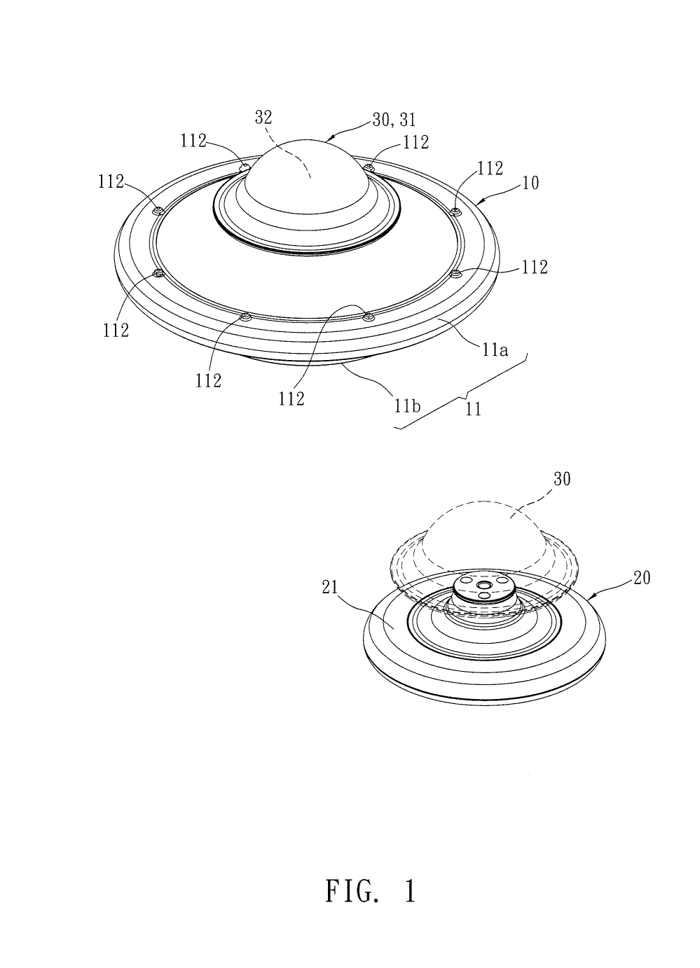

Refer to FIG. 1, a floating water show speaker of the present invention includes a first control unit 10, a second control unit 20 and an audio unit 30.

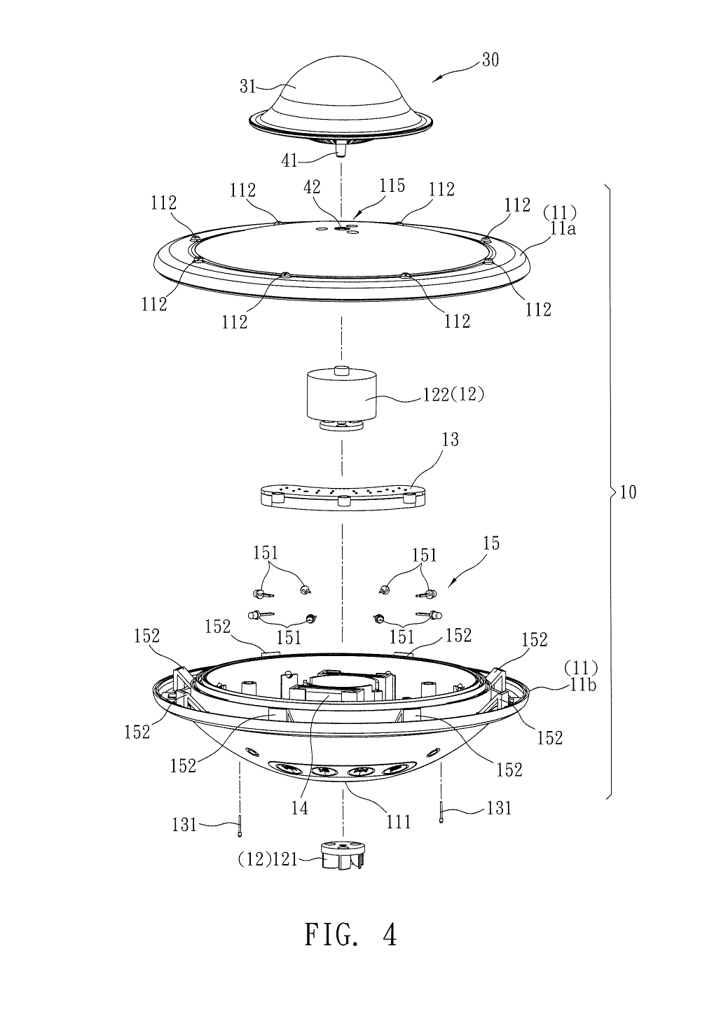

As shown in FIG. 4, the first control unit 10 having a housing 11, a pump 12 and a first control circuit 13 is suitable to be used in water.

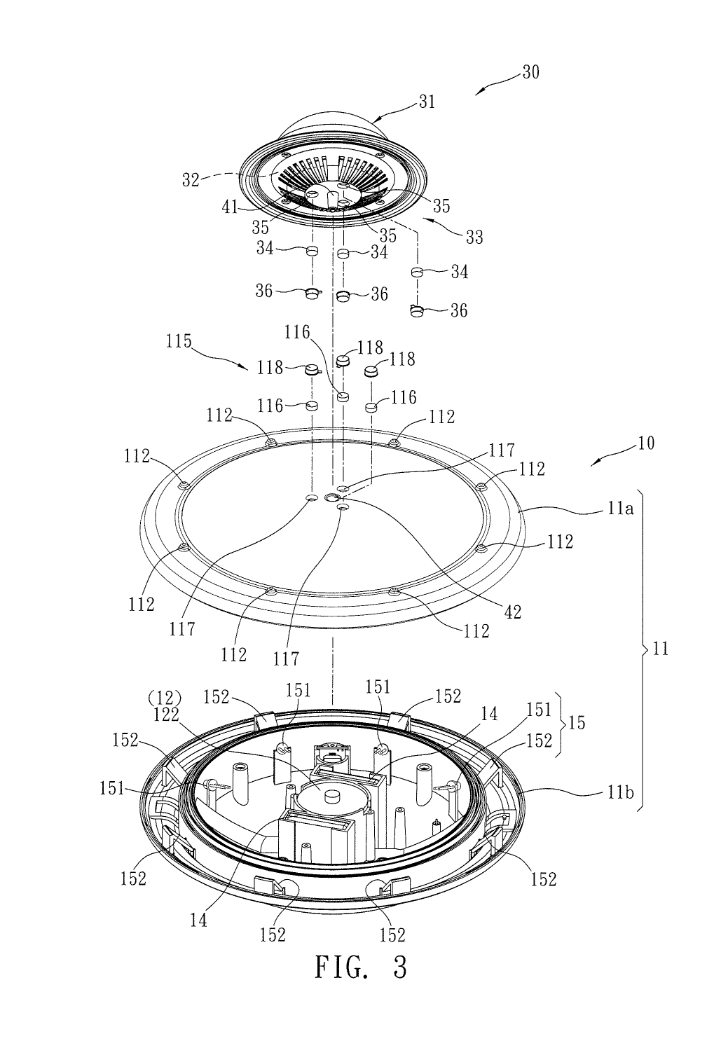

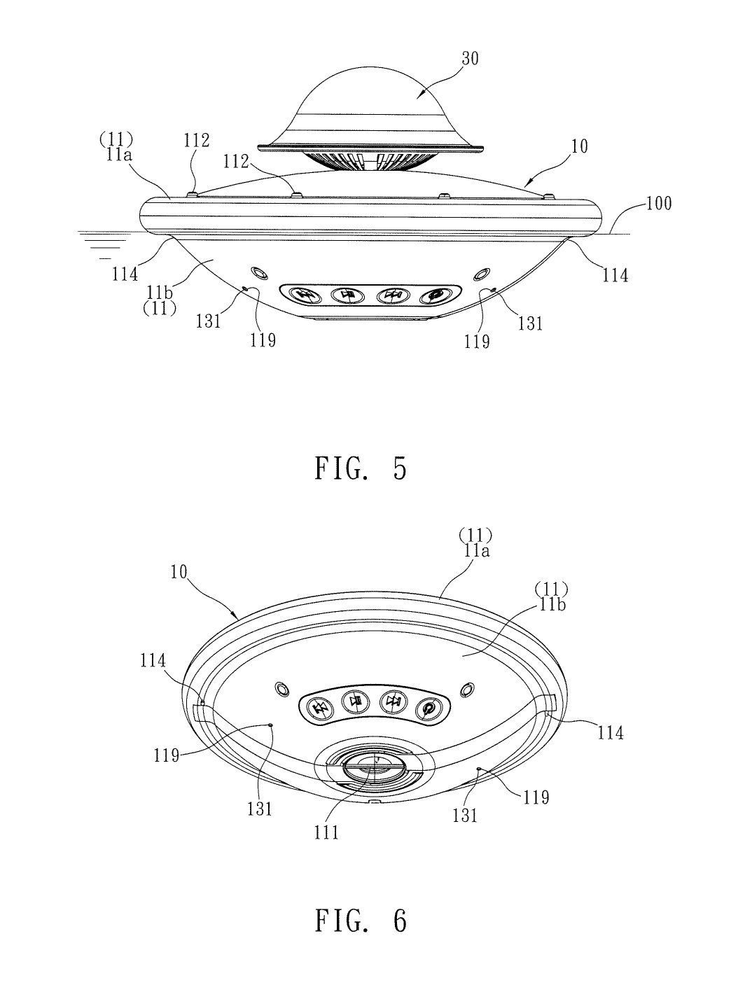

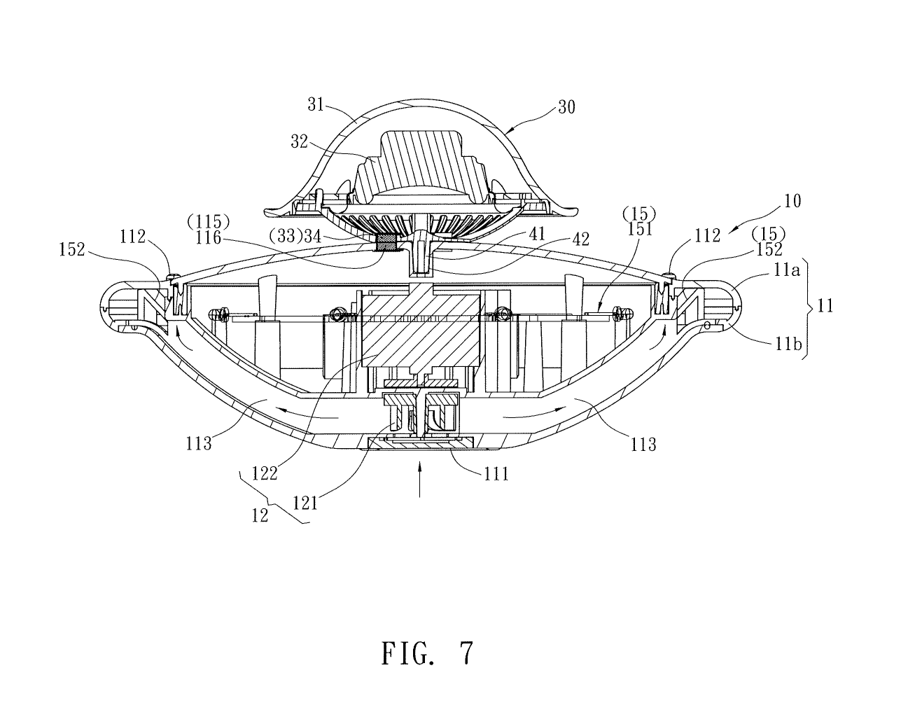

Refer to FIG. 3, FIG. 4 and FIG. 7, the housing 11 consists of an upper housing 11a and a lower housing 11b corresponding and connected to each other to form a hollow air chamber therein. Thus the housing 11 can float in the water. A seal ring (not shown in figure) is arranged at the connection area between the upper housing 11a and the lower housing 11b for providing better sealing. A bottom surface of the lower housing 11b is arranged with a water inlet 111. A plurality of first spray holes 112 is disposed on and penetrating a top surface of the upper housing 11a. The first spray holes 112 are arranged in a circular pattern, a radial pattern or other preset patterns. At least one channel 113 that communicates the first spray holes 112 to the water inlet 111 is set on the housing 11. As shown in FIG. 5 and FIG. 6, the lower housing 11b is further arranged with at least one second water spray hole 114 that is penetrating the lower hosing 11b and tangent to the outer surface of the lower housing 11b. The second water spray hole 114 is also communicated with the channel 113. The second water spray hole 114 can be arranged in a horizontal manner or inclined outward and downward. The position of the second water spray hole 114 allows the second water spray hole 114 to be immersed into water 100 so that the water 100 is passed through the second water spray hole 114 while being drawn into the channel 113. When the water 100 is injected in the direction tangent to the outer surface of the lower housing 11b, the housing 11 is rotated. When there is a plurality of second water spray holes 114, all the second water spray holes 114 are arranged evenly at the same height.

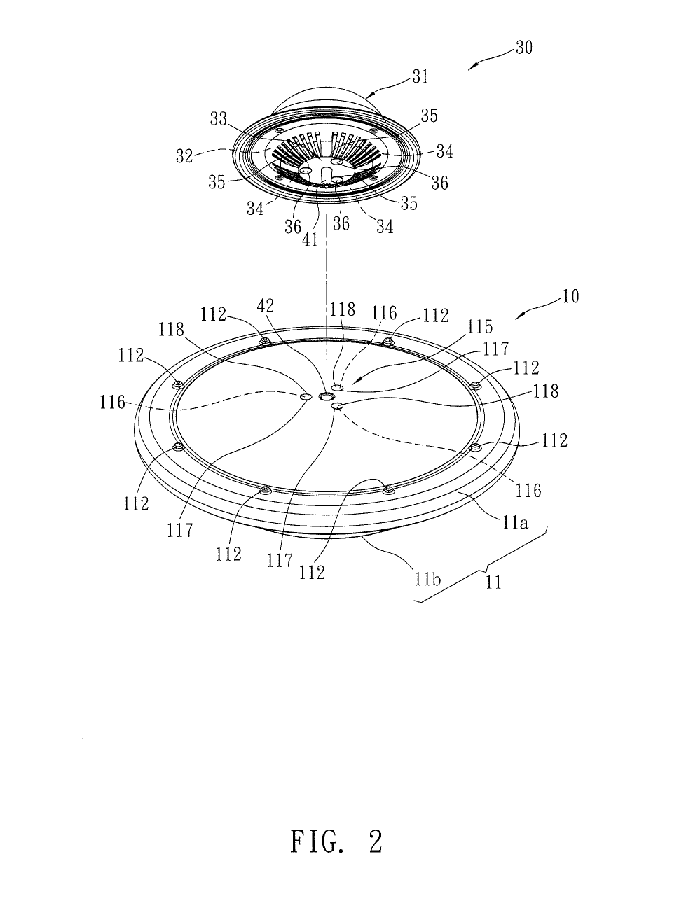

Refer to FIG. 2, FIG. 3 and FIG. 4, the top surface of the upper housing 11a is set with a first connection part 115. The first connection part 115 is formed by at least three first magnets 116, at least three first concave holes 117 for mounting the first magnets 116 respectively and at least three first protection components 118 each of which covers the first magnet 116 correspondingly for preventing exposure and oxidation of the first magnet 116. The position of the first connection part 115 and the positions of the first spray holes 112 are different from each other.

Refer to FIG. 3, FIG.4, FIG. 6 and FIG. 7, the pump 12 is mounted in the housing 11. An input end of the pump 12 is communicated with the outside through the water inlet 111 of the housing 11. The pump 12 can be a magnetic drive pump formed by blades 121 and a motor 122. The motor 122 drives the blades 121 to rotate by using a magnetic force. The blades 121 are mounted correspondingly in the water inlet 111 of the housing 11. The blades 121 are located at the input end of the pump 12.

The first control circuit 13 is disposed in the housing 11 and is electrically connected to the pump 12 for control of the pump 12 including power-on, power-off, rotation speed, etc. After power-on, the pump 12 draws the water through the water inlet 111 of the housing 11 and forces the water through the channel 113 and the first spray holes 112 to be jetted in the form of a column. At the same time, the water is also passed through the second spray holes 114 to be jetted in the direction tangent to the outer surface of the lower housing 11b. Thus the housing 11 is rotated in the water. Moreover, the first control circuit 13 can also output audio signals.

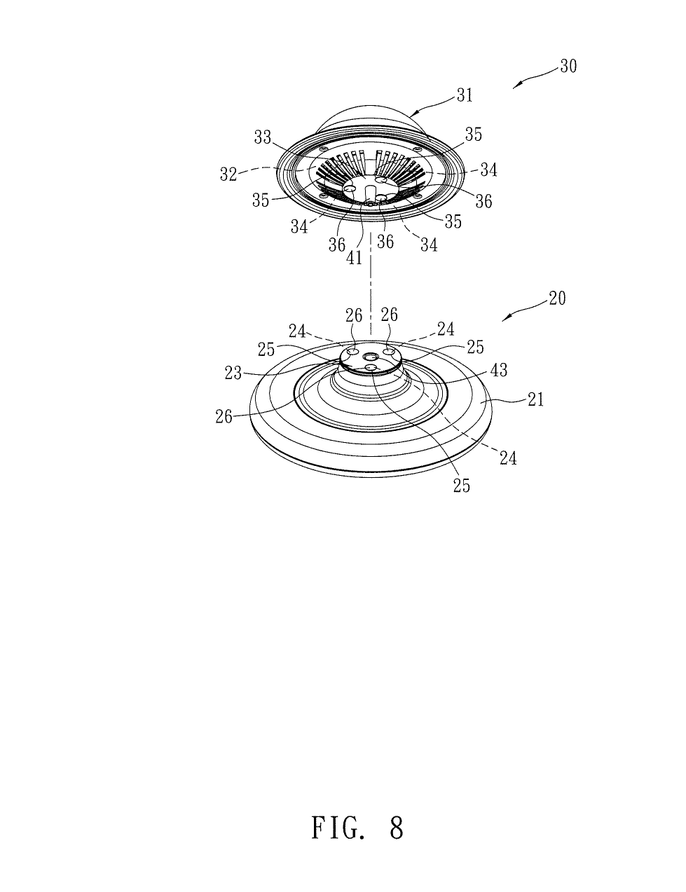

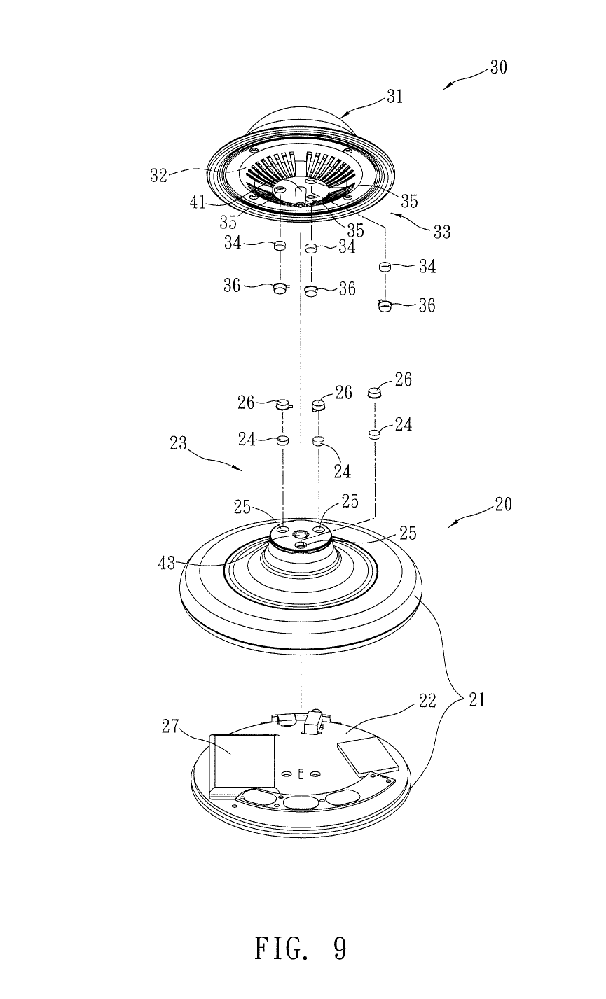

Refer to FIG. 1, FIG. 8 and FIG. 9, the second control unit 20 is suitable to be used on a flat surface. The second control unit 20 consists of a base 21, a second control circuit 22 mounted in the base 21, and a second connection part 23 disposed on one side of the base 21. The second connection part 23 is formed by at least three second magnets 24, at least three second concave holes 25 for mounting the second magnets 24 respectively and at least three second protection components 26 that cover the second magnets 24 correspondingly for preventing exposure and oxidation of the second magnets 24. Moreover, the second control unit 20 is able to output audio signals. As shown in the figures mentioned above, the second connection part 23 is formed on the top surface of the base 21.

The audio unit 30 is composed of a speaker enclosure 31 with at least one speaker driver 32. The speaker driver 32 is used to receive an audio signal from the first control unit 10/or the second control unit 20 and send the audio signal to the speaker driver 32 for playing the audio signal. The on/off and sound intensity of the audio unit 30 are also controlled by the audio signal. A third connection part 33 is set on one side of the speaker enclosure 31. The third connection part 33 includes at least three third magnets 34, and at least three third concave holes 35 for mounting the third magnets 34 respectively. The third connection part 33 further has three third protection components 36 that cover the third magnets 34 correspondingly for preventing exposure and oxidation of the third magnets 34.

The third magnets 34 and the first magnets 116 attract each other correspondingly and so are the third magnets 34 and the second magnet 24. Thereby the third connection part 33 on the speaker enclosure 31 is electrically connected to the first connection part 115 of the first control unit 10 by means of the magnetic force. Thus the first control unit 10 can send the audio signal to the speaker driver 3 when the third magnets 34 and the first magnets 115 are attracted and electrically connected. Or the third connection part 33 on the speaker enclosure 31 is electrically connected to the second connection part 23 of the second control unit 20 by means of the magnetic force. Thus the second control unit 20 can send the audio signal to the speaker driver 3 when the third magnets 34 and the second magnets 24 are attracted and electrically connected. In the embodiment shown in FIG. 2, FIG. 3, and FIG. 7 to FIG. 9, the third connection part 33 is formed on a bottom surface of the speaker enclosure 31.

Refer to FIG. 3, FIG. 4, and FIG. 7, the first control unit 10 further includes a first power supply unit 14 and a light unit 15. The first power supply unit 14 is set in the housing 11 and is electrically connected to the first control circuit 13 for power supply of the first control unit 10. The first power supply unit 14 can be a built-in battery for safety and convenience. The battery is a primary battery or a rechargeable battery. The light unit 15 is mounted in the housing 11 and is electrically connected to the first control circuit 13. The on/off and flash patterns of the light unit 15 are controlled by the first control circuit 13. The light unit 15 includes light emitting diode (LED) lights 151 and at least one reflecting mirror 152. The LED lamp 151 emits light while the reflecting mirror 152 reflects the light from the LED lamp 151 to the water column so as to form the colored water column.

Refer to FIG. 9, the second control unit 20 further includes a second power supply unit 27. The second power supply unit 27 is mounted in the base 21 and is electrically connected to the second control circuit 22 for providing power to the second control unit 20. The second power supply unit 27 can be a built-in battery for safety and convenience. The battery is a primary battery or a rechargeable battery.

In order to prevent the pump 12 from being activated by the first control unit 10 due to accidental contact, a protection component for security of the first control unit 10 is preset in the first control unit 10. The lower housing 11b of the housing 11 is mounted with at least one hole 119. The first control circuit 13 further includes at least one probe 131 and the probe 131 is located in the hole 119, as shown in FIG. 4, FIG. 5 and FIG. 6. The probe 131 is in contact with the water 100 and a close circuit is formed in the first power supply unit 14 when the probe 13 is in a first state. When the probe is in a second state, the probe 131 is not in contact with the water 100 and an open circuit is formed between the pump 12 and the first power supply unit 14. The first control unit 10 works normally when the probe 131 is in the first state. That means the housing 11 is correctly set and floated in the water 100 while the probe 131 is in contact with the water 100. When the probe 131 is in the second state, the pump 12 of the first control unit 10 can't be activated and used. That means the housing 11 is not set into the water 100 or the water level is not high enough to keep the probe 131 in contact with the water 100. Thereby the security of the first control unit 10 is achieved.

The second control unit 20 further sends a control signal to the first control unit 10. Then the first control unit 10 takes different actions including rotation, water dance, audio visual effect, etc. according to the control signal.

In the embodiments shown in FIG. 2 to FIG. 4 and FIG. 7 to FIG. 9, the third connection part 33 of the speaker enclosure 31 is further disposed with a projecting pin 41 extended outward while the first connection part 115 of the housing 11 is arranged with a recess 42 corresponding to the projecting pin 41. The speaker enclosure 31 is firmly connected to the housing 11 by the projecting pin 41 being mounted into the recess 42. Similarly, the second connection part 23 of the base 21 is set with a recess 43 corresponding to the projecting pin 41. By the projecting pin 41 being mounted into the recess 43, the speaker enclosure 31 is stably assembled with the base 21. In other embodiments, the positions of the projecting pin 41 and the recess 42, 43 are interchangeable.

The first control unit 10 and the second control unit 20 are at separate positions and used together with the audio unit 30 respectively. There are two modes of use. In a first mode of use, the audio unit 30 is connected to the first control unit 10. In a second mode of use, the audio unit 30 is used together with the second control unit 20.

In the first mode of use, the first control unit 10 is set into the water 100 with a preset depth so as to make a part of or the whole lower housing 11b of the housing 11 immerse in the water 100 and keep the second water spray hole 114 below the surface of the water 100, as shown in FIG. 5. The speaker enclosure 31 is disposed on the top surface of the housing 11 while the third magnets 34 and the first magnets 116 are attracted and electrically connected to each other correspondingly. Thus the first power supply unit 14 is activated for providing power to the first control unit 10 after confirmation of the probe 131 in the first state. Then the audio unit 30 starts to play the music and the pump 12 begins to drive the water 100 into the water inlet 111 of the housing 11 and then push the water 100 out through the channel 113 and the first spray holes 112 to create a dancing water show. The hosing 11 is also driven to rotate by a part of the water jetted through the second water spray hole 114. Thus the audio unit 30 plays the music and the light unit 15 emits light in this mode of use. During the process, the housing 11 is rotated while the first control unit 10 is creating the dancing water show and the audio visual effect for sensory stimulus.

In the second mode of use, the second control unit 20 is set on the flat surface. Then the speaker enclosure 31 is arranged the top surface of the base 21 while the third magnets 34 and the second magnets 24 are attracted and electrically connected to each other correspondingly. Thus the second power supply unit 27 is activated for providing power to the second control unit 20. At the moment, the audio unit 30 starts to play the music. The second control unit 20 can also send a control signal to the first control unit 10. Thus the housing 11 is rotated and the control unit 10 is creating the dancing water show, as mentioned in the first mode of use.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A separable floating water show speaker comprising:
a first control unit suitable to be used in water and including
a housing having an upper hosing and a lower housing with a hollow air chamber therebetween so that the housing is able to float in the water; wherein a bottom surface of the lower housing is arranged with a water inlet and a plurality of first spray holes is mounted on and penetrating a top surface of the upper housing; at least one channel for communicating the first spray holes with the water inlet is also arranged at the housing and a first connection part is disposed on the top surface of the upper housing while the first connection part includes at least three first magnets;
a pump mounted in the housing and having an input end thereof communicated with outside through the water inlet of the housing; and a first control circuit disposed in the housing and electrically connected to the pump for control of the pump; wherein the pump draws the water through the water inlet of the housing and forces the water through the channel and the first spray holes to be jetted in a form of a water column;
a second control unit suitable to be used on a flat surface and having
a base,
a second control circuit mounted in the base, and a second connection part disposed on one side of the base; wherein the second connection part includes at least three second magnets; and
an audio unit having a speaker enclosure with at least one speaker driver and used for receiving an audio signal from the first control unit or the second control unit and sending the audio signal to the speaker driver to be played;
wherein a third connection part is set on one side of the speaker enclosure and the third connection part includes at least three third magnets; the three third magnets and the three first magnets are attracted so as to connect the third connection part of the speaker enclosure with the first connection part of the first control unit; the three third magnets and the three second magnets are attracted so as to connect the third connection part of the speaker enclosure with the second connection part of the second control unit; the third connection part on the speaker enclosure is connected to the first connection part of the first control unit by means of magnetic force; the third connection part on the speaker enclosure is connected to the second connection part of the second control unit by means of magnetic force;
wherein the first control unit sends the audio signal to the speaker driver when the three third magnets and the three first magnets are attracted and electrically connected;
wherein the second control unit sends the audio signal to the speaker driver when the three third magnets and the three second magnets are attracted and electrically connected.

2. The device as claimed in claim 1, wherein the first connection part further includes at least three first concave hole for mounting the three first magnets respectively and at least three first protection components that cover the three first magnets correspondingly for preventing exposure and oxidation of the first magnets.

3. The device as claimed in claim 1, wherein the second connection part further includes at least three second concave hole for mounting the three second magnets respectively and at least three second protection components that cover the three second magnets correspondingly for preventing exposure and oxidation of the second magnets.

4. The device as claimed in claim 1, wherein the third connection part further includes at least three third concave hole for mounting the three third magnets respectively and at least three third protection components that cover the three third magnets correspondingly for preventing exposure and oxidation of the third magnets.

5. The device as claimed in claim 1, wherein the lower housing is further arranged with at least one second water spray hole; the second water spray hole is penetrating the lower hosing and is tangent to an outer surface of the lower housing; the second water spray hole is communicated with the channel so that water is passed through the second water spray hole to be injected in a direction tangent to the outer surface of the lower housing.

6. The device as claimed in claim 1, wherein the first control unit further includes a first power supply unit mounted in the housing and electrically connected to the first control circuit for power supply of the first control unit.

7. The device as claimed in claim 6, wherein the lower housing of the housing is mounted with at least one hole and the first control circuit further includes at least one probe while the probe is located in the hole; the probe is in contact with the water and a close circuit is formed in the first power supply unit when the probe is in a first state; the probe is not in contact with the water and an open circuit is formed between the pump and the first power supply unit while the probe is in a second state.

8. The device as claimed in claim 1, wherein the second control unit further includes a second power supply unit; the second power supply unit is mounted in the base and is electrically connected to the second control circuit for providing power to the second control unit.

9. The device as claimed in claim 1, wherein the first control unit further includes a light unit; the light unit is electrically connected to the first control circuit so that on, off and flash patterns of the light unit are under control of the first control circuit; the light unit further includes at least one reflecting mirror that reflects the light from the light unit to the water column so as to form the water column with colors.

10. The device as claimed in claim 1, wherein the third connection part of the speaker enclosure is further disposed with a projecting pin extended outward while the first connection part of the housing is arranged with a recess corresponding to the projecting pin; the projecting pin is mounted into the recess; the second connection part of the base is set with a recess corresponding to the projecting pin and used for mounting the projecting pin.
